(19) United States
(12) Patent Application Publication
(10) Pub. No.: US 2015/0375164 A1
(43) Pub. Date: Dec. 31, 2015

(54) PROCESS AND APPARATUS FOR PROCESSING A GAS STREAM AND ESPECIALLY FOR PROCESSING A FLUE GAS STREAM

(71) Applicant: SIEMENS AKTIENGESELLSCHAFT, München (DE)

(72) Inventors: Kevin Brechtel, Uehlfeld (DE); Bjorn Fischer, Dusseldorf (DE); Ralph Joh, Seligenstadt (DE); Rudiger Schneider, Eppstein (DE)

(73) Assignee: Siemens Aktiengesellchaft, Munich (DE)

(21) Appl. No.: 14/768,842

(22) PCT Filed: Feb. 3, 2014
(86) PCT No.: PCT/EP2014/052028

§ 371 Date: Aug. 19, 2015

(30) Foreign Application Priority Data
Feb. 21, 2013 (DE) 10 2013 202 831.8

(51) Int. Cl. B01D 53/14

(52) U.S. Cl. CPC B01D 53/1406; B01D 53/1425; B01D 53/1475; B01D 53/1493; B01D 2252/20494

(57) ABSTRACT

An apparatus for processing a gas stream and especially for processing a flue gas stream, includes a scrubbing apparatus for removing harmful substances from the gas stream by means of a scrubbing medium, and a separation apparatus which is connected downstream of the washing apparatus and comprises an absorber and a desorber for separation of carbon dioxide from the gas stream by means of a scrubbing medium. In this context, the scrubbing apparatus and the separation apparatus are set up to use the same scrubbing medium. A process uses the same scrubbing medium both for pre-purification of the gas stream in a scrubbing apparatus and for separation of carbon dioxide in a separation apparatus.

### CROSS REFERENCE TO RELATED APPLICATIONS

This application is the US National Stage of International Application No. PCT/EP2014/052028 filed Feb. 3, 2014, and claims the benefit thereof. The International Application claims the benefit of German Application No. DE 102013202831.8 filed Feb. 21, 2013. All of the applications are incorporated by reference herein in their entirety.

### FIELD OF INVENTION

The invention relates to an apparatus for processing a gas stream, and in particular for processing a flue gas stream. In addition, the invention relates to a corresponding process for processing a gas stream.

### BACKGROUND OF INVENTION

Against the background of climatic change, it is a global target to decrease the emission of harmful substances into the atmosphere. This applies, in particular, to the emission of carbon dioxide (CO₂), which collects in the atmosphere, impedes the radiation of heat away from the Earth and thus, as a greenhouse effect, leads to an increase in the Earth's surface temperature.

Particularly in the case of fossil-fueled power plants for generating electrical energy, a carbon dioxide-containing flue gas is formed by the combustion of a fossil fuel. To avoid or decrease carbon dioxide emissions into the atmosphere, the carbon dioxide must be separated off from the flue gas. Correspondingly, in particular in the case of existing fossil-fueled power plants, suitable measures are being discussed in order to separate off from the flue gas the resultant carbon dioxide after the combustion (post-combustion capture).

As a technical implementation, for this purpose, the flue gas after combustion is brought into contact with a suitable scrubbing medium, wherein gaseous carbon dioxide present in the flue gas is dissolved, or in the chemical sense absorbed in the scrubbing medium. The exhaust gas freed from carbon dioxide is finally discharged into the atmosphere. The scrubbing medium loaded with carbon dioxide can be regenerated by desorption of the absorbed carbon dioxide and used again for absorption of carbon dioxide from the flue gas.

Established scrubbing media are based in this case on primary, secondary or tertiary amines and exhibit good selectivity and high capacity for carbon dioxide.

However, a problem in separating off the CO₂ from a flue gas in the post-combustion capture process results from the harmful substances such as solid particles, sulfur oxides (SOₓ) and nitrogen oxides (NOₓ) that are present in the flue gas in addition to the carbon dioxide and which are introduced via the flue gas into the CO₂-separation process. In this case, for example owing to the reaction of the amines from the scrubbing medium with the nitrogen oxides from the flue gas, nitrosamines (N-nitroso compounds) are formed directly, via breakdown products, or via side reactions, which nitrosamines are suspected of being carcinogenic. Since the nitrosamines formed have a low vapor pressure, they are co-discharged into the atmosphere via the purified flue gas. Minimization of the nitrosamine concentration in CO₂ separation is therefore absolutely necessary.

In order to separate off the gaseous harmful substances such as SOₓ and NOₓ, likewise solid particles, from the flue gas before entry into a CO₂ separation apparatus, the flue gas is usually prepurified in a scrubbing apparatus. In this case, use is made of, for example, dust separators for freeing the flue gas from solids, desulfurization units for removal of SOₓ, and what are termed DeNOₓ units for removal of NOₓ.

By means of these processes, a majority of the harmful substances present in the flue gas can usually be removed in the sense of a prepurification. However, it is not possible to exclude a remnant of a residual fraction, in particular of nitrogen oxides, in the flue gas. These harmful substances are then fed together with the flue gas to the CO₂ separation apparatus and there, together with the scrubbing medium, form harmful gases and breakdown products such as, in particular, the abovedescribed nitrosamines.

### SUMMARY OF INVENTION

It is therefore a first object of the invention to specify a novel apparatus which, in comparison with established apparatus, permits simplified flue gas processing with simultaneous avoidance of the formation of unwanted breakdown and byproducts in the CO₂ separation process.

A second object of the invention is to specify a process which is optimized with respect to the formation of breakdown and byproducts in flue gas processing.

The first object of the invention is achieved according to the invention by an apparatus for processing a gas stream and in particular a flue gas stream, comprising a scrubbing apparatus for removing harmful substances from the gas stream by means of a scrubbing medium, and also a separation apparatus connected downstream of the scrubbing apparatus and having an absorber and a desorber for separating off carbon dioxide from the gas stream by means of a scrubbing medium. In this case the scrubbing apparatus and the separation apparatus are equipped for use of the same scrubbing medium.

The invention proceeds from the fact that the formation of breakdown and byproducts in a CO₂ separation apparatus, particularly owing to the harmful substances, and particularly the nitrogen oxides, introduced together with the flue gas is only able to be impeded with restrictions to date. Despite a prepurification of the flue gas, usually a certain fraction of harmful substances always remains in the flue gas. This residual fraction is fed together with the flue gas to the carbon dioxide separation apparatus and there participates in reactions with the scrubbing medium, as a result of which the formation of unwanted byproducts and/or breakdown products is favored. Even the use of a scrubbing medium together with additives which, for example, owing to the reaction with the nitrogen oxides present in the flue gas, could reduce the concentration thereof, cannot ensure to date a virtually complete removal of the nitrogen oxides.

Taking into account the abovementioned, the invention recognizes that the formation of unwanted products in the separation of CO₂ from the flue gas can be prevented when not only the scrubbing apparatus for separating off harmful substances present in the gas stream, but also the separation apparatus for separating off carbon dioxide from the gas stream are constructed in such a manner that they are suitable for using the same scrubbing medium.

By using the same scrubbing medium for both processing steps, that is to say for prepurifying the flue gas for removing the harmful substances before entry into the CO₂ separation apparatus, and for the absorption-desorption process within the CO₂ separation apparatus, a safe and inexpensive processing of a flue gas can be ensured.

The scrubbing medium (first process stage) serves firstly for the reduction or removal of interfering components in the flue gas (harmful gases, solid particles and heavy metals) and thus prevents intake thereof into the separation apparatus (second process stage). Secondly, the scrubbing medium permits separation of carbon dioxide from the flue gas by familiar absorption-desorption processes in a corresponding separation apparatus.

In other words, as a result of the suitability of the scrubbing apparatus and the CO₂ separation apparatus for use of the same scrubbing medium, a two-stage process for flue gas purification can be implemented in such a manner that in the first process stage the harmful substances are separated off in a targeted manner and in the second process stage the flue gas that is virtually completely free of unwanted components is purified by final separation off of carbon dioxide.

The purified flue gas, after passage through the scrubbing apparatus, contains no, or only a vanishingly small amount of, harmful substances, and can thus be fed to the separation apparatus. On account of the prior removal of the harmful substances, formation of unwanted byproducts and breakdown products and, in this case in particular nitrosamines, can be suppressed or at least substantially reduced.

In addition, this configuration permits flue gas cooling to be implemented together with separating off the harmful substances in a shared scrubbing apparatus. This firstly saves capital costs and reduces the harmful substances in the main process, that is to say the carbon dioxide separation process, considerably. Also, feed of a separate scrubbing medium such as, for example, sodium hydroxide (NaOH) solution, can be dispensed with, as a result of which the waste stream can be markedly diminished, and thereby the operating costs can be reduced.

In principle, a flue gas formed in the combustion in a coal power plant can be purified in three successive stages. In the first stage, in the context of a flue gas denitration, nitrogen oxides are removed from flue gas, for which purpose, typically, what is termed the selective catalytic reaction (SCR) process is employed. Subsequently, the flue gas is dedusted for removal of solid particles. In a third step, the flue gas is subjected to a desulfurization for removing sulfur oxides.

In the present case, for the prepurification, in particular a prescrubber part of the scrubbing apparatus is used, for example in the form of a prescrubber column. In the scrubbing apparatus (first process stage) or in the prescrubber thereof, the prepurification and cooling of the flue gas takes place. In this case, the harmful substances are removed from the flue gas.

The carbon dioxide remaining in the flue gas after the prepurification is usually scrubbed out of the respective gas stream by means of a scrubbing medium via an absorption-desorption process. For the separation, the flue gas is fed to an absorber as part of a familiar CO₂ separation apparatus. In order to favor the absorption process in the absorber, the flue gas is generally cooled in what is termed a flue gas cooler before entry into the absorber. In the present case, the cooling is advantageously performed simultaneously with the removal of the harmful substances already in the scrubbing apparatus. The reduced flue gas temperature required for the absorption of CO₂ in the scrubbing medium can thus be achieved in one step with the first prepurification.

The gas stream is brought into contact with the scrubbing medium within the absorber, wherein there subcomponents and CO₂ are absorbed or reversibly bound. The purified flue gas is discharged from the absorber, whereas the loaded scrubbing medium is passed into a desorber for separating off CO₂ with temperature increase. The separation in the desorber usually proceeds thermally, that is to say the carbon dioxide is desorbed by supply of heat and expelled and can then be fed to a storage or utilization. The regenerated scrubbing medium is recycled from the desorber to the absorber and is then once more available for the absorption of CO₂ from the flue gas.

In particular, an amino acid salt is used as scrubbing medium. By using an amino acid salt as a shared scrubbing medium for the scrubbing apparatus and the CO₂ separation apparatus, processing a flue gas with existing or already existent reclaiming processes is possible. An aqueous amino acid salt solution is expedient in this case. In the use of an amino acid salt as absorption medium, it has proved to be advantageous if an amino acid salt is used that has a carbon substituent from the group containing hydrogen, an alkyl, a hydroxyalkyl and an aminoalkyl. Further advantageously, an amino acid salt is used that has a nitrogen substituent from the group containing hydrogen, an alkyl, a hydroxyalkyl and a haloalkyl. In addition, a single amino acid salt such as, for example, a potassium salt of glycine or other amino acids can be used. Also, mixtures of different amino acid salts can be used as absorption medium. Further advantageously, the amino acid salt is a salt of a metal, in particular an alkali metal.

In a particularly advantageous embodiment of the invention, a regeneration stage for the scrubbing medium is comprised having a number of reclaimers. In the regeneration stage or in the respective reclaimers associated with the regeneration stage, decomposition products and also non-regenerable reaction products are separated off from the scrubbing medium. This can proceed, for example, by means of a distillation, in which the scrubbing medium which is condensed after separating off the interfering components is again fed to the scrubbing apparatus. The reclaimers serve in this case, with regeneration of the scrubbing medium, for targeted ejection of interfering matter, and likewise for the production of utilizable products from the flue gas.

In principle, the regeneration stage or the or each reclaimer of the regeneration stage can be flow-connected to a desorber. Thus, the scrubbing medium purified after the desorption of carbon dioxide can be regenerated in the regeneration stage.

With respect to the arrangement of the regeneration stage however, it has proved to be particularly advantageous when the regeneration stage is flow-connected to a recycle line of the scrubbing apparatus. The recycle line of the scrubbing apparatus in this case is advantageously connected to the prescrubber of the scrubbing apparatus. In this manner, the scrubbing medium circulating in the scrubbing apparatus proceeding from the prescrubber can be fed to the regeneration stage and correspondingly processed and/or regenerated. A temperature increase to achieve desorber conditions for expelling the carbon dioxide from the scrubbing medium is not necessary. By a regeneration stage coupled to the scrubbing apparatus, high temperatures are thus avoided and separating off harmful substances with regeneration of the scrubbing medium without formation of unwanted and hazardous byproducts and breakdown products, such as nitrosamines, is implemented.

Also the residual fraction of sulfur oxides present in the flue gas after the prepurification, which residual fraction was to date co-introduced into the separation apparatus and not removed from the scrubbing medium until connection to the CO₂ desorption by regeneration of the scrubbing medium, can now, thanks to the flow-connection of the scrubber circuit to the regeneration stage, be removed from the flue gas as soon as before entry into the CO₂ separation apparatus, for example by precipitation as potassium sulfate (K₂SO₄).

The regeneration stage is flow-connected to the scrubbing apparatus, expediently via the recycle line of the scrubbing apparatus. For this purpose, the recycle line advantageously comprises a branch line which is flow-connected in each case to a feed line of the or each reclaimer of the regeneration stage. Further advantageously, the or each reclaimer comprises a recycle line which is flow-connected in each case to the recycle line of the scrubbing apparatus. Thus, the scrubbing medium processed in the reclaiming process of the regeneration stage can be fed to the scrubbing apparatus and there be used for further separation of harmful substances from the flue gas. Overall, the scrubbing medium can be fed to the or each reclaimer of the regeneration stage via the coupling to the scrubbing apparatus, processed there, and again recycled to the scrubbing apparatus.

Overall, the scrubbing medium can be fed to the or each reclaimer via the flow connection to the scrubbing apparatus, processed there, and recycled via the recycle lines back into the scrubbing apparatus.

Further advantageously, a first reclaimer and a second reclaimer are flow-connected to one another via a connection line, in such a manner that scrubbing medium processed in the first reclaimer can be further regenerated in the second reclaimer. For example, in the first reclaimer, potassium sulfate can be obtained for further use, and in the second reclaimer, further interfering components can be separated off which are disposed of as a waste stream. From the second reclaimer, the purified scrubbing medium is then fed back to the scrubbing apparatus.

Expediently, in each case a processing appliance is connected to the outlet line of the or each reclaimer. The products formed in the reclaiming processes of the scrubbing medium such as, particularly, potassium sulfate, water and waste products, can be appropriately further processed in the processing appliances connected to the reclaimers. For instance, potassium sulfate formed can be used as fertilizer, for example, after further processing. The waste stream produced is particularly small thanks to the reclaiming process already carried out in the scrubbing apparatus.

Advantageously, the absorber of the separation apparatus comprises an outlet line which is flow-connected to a feed line of the desorber. The CO₂-loaded scrubbing medium is thus passed into the desorber for separation off of CO₂ with temperature increase. During the feed of the loaded scrubbing medium to the desorber, it is expediently pumped there by means of a pump, wherein the loaded scrubbing medium passes through a heat exchanger. In the heat exchanger, the heat of the regenerated scrubbing medium flowing from the desorber to the absorber is transferred to the loaded scrubbing medium flowing from the absorber. The heat exchanger thereby utilizes the waste heat in the recycle line of the desorber in order to preheat the scrubbing medium from the absorber before entry into the desorber. Separating off the carbon dioxide from the scrubbing medium usually proceeds thermally.

Expediently, the desorber of the separation apparatus is flow-connected via a recycle line to a feed line of the absorber. Thus, the scrubbing medium freed from CO₂ in the desorber can be fed to the absorber and is there again available for the absorption of carbon dioxide.

In a particularly advantageous embodiment of the invention, a branch line is connected to the recycle line of the desorber, which branch line is flow-connected to the feed line of the scrubbing apparatus. Scrubbing medium flowing off from the desorber can in this manner be recycled to the scrubbing apparatus and there be used for separating off the harmful substances from the flue gas. In addition, the scrubbing medium can be fed to the regeneration stage and thereby to the reclaiming process and regenerated therein. Such an embodiment is a coupled operating mode of the first process stage, that is to say the prepurification of the flue gas in the scrubbing apparatus, and of the second process stage, that is to say the CO₂ separation process. Such a coupled operating mode can be implemented, in particular, because not only the scrubbing apparatus, but also the separation apparatus are designed for use of the same scrubbing medium.

Further advantageously, a branch line is connected to the outlet line of the absorber, which branch line is flow-connected to the feed line of the scrubbing apparatus. In this manner, scrubbing medium already flowing off from the absorber can be recycled to the scrubbing apparatus and there used for separating off the harmful substances from the flue gas.

Advantageously, an outlet line is connected to the desorber, which outlet line opens out in a processing appliance. The processing appliance serves for processing and transferring the desorbed carbon dioxide to further products. For example, the remaining CO₂-rich gas stream can be compressed, in order to permit transport to a storage site, where the CO₂ can finally be stored.

In a further advantageous embodiment, the scrubbing apparatus is thermally connected to the outlet line of the absorber. The coupling proceeds in this case via a heat exchanger which is advantageously incorporated in the outlet line of the absorber. In this manner heat can be taken off from the main process, that is to say the CO₂ separation process, which is then available for the evaporation in the prepurification. An additional heat input is therefore unnecessary.

The waste heat from the outlet line of the absorber can in this case advantageously be used for the recovery of water in the scrubbing apparatus. For this purpose, the heat exchanger in the outlet line of the absorber is expediently connected to a heat exchanger of the scrubber circuit. Then, for example a compressor and a steam condenser for liquefying the water vapor can be connected to the heat exchanger of the scrubber circuit.

In a further advantageous embodiment, the regeneration stage is thermally connected to the outlet line of the absorber. The heat from the CO₂ separation process can in this manner be used, for example, directly for evaporating water in the regeneration stage. In this case, advantageously at least one reclaimer of the regeneration stage is thermally connected via a heat exchanger to the outlet line of the absorber.

In a particular embodiment, the scrubbing apparatus and the absorber of the separation apparatus are arranged in a shared column. In this manner, the cooling of the flue gas, the separation off of the harmful substances and the carbon dioxide separation can be arranged in a space-saving manner. The column for this purpose is designed, in particular, in such a manner that the flue gas that is freed from harmful substances and cooled in the lower part of the column ascends into the upper part of the column for the absorption of carbon dioxide, where the carbon dioxide is removed from the flue gas. Via an outlet at the top end of the column, the flue gas thus purified can be discharged into the atmosphere.

Expediently, a reboiler is connected to the desorber. The reboiler, as what is termed a sump evaporator, delivers the necessary heat of regeneration for the separation of absorbed CO₂ from the scrubbing medium. The loaded scrubbing medium in this case is regenerated by steam that is generated in the reboiler. For production of the steam within the reboiler, the reboiler is usually heated with imported steam, for example from a connected steam power plant.

The second object of the invention is achieved according to the invention by a process for processing a gas stream, in particular for processing a flue gas stream, in which in a scrubbing apparatus, harmful substances are separated off from the gas stream by means of a scrubbing medium, the gas stream freed from harmful substances is fed to a separation apparatus to separate off carbon dioxide, within an absorber of the separation apparatus the carbon dioxide is separated off from the gas stream by means of a scrubbing medium, and the loaded scrubbing medium is fed to a desorber of the separation apparatus for desorption of the carbon dioxide. In this case the same scrubbing medium is used to separate off the harmful substances and to separate off the carbon dioxide from the gas stream.

The scrubbing medium serves firstly to decrease or remove interfering components in the flue gas and thus prevent input thereof into the carbon dioxide separation apparatus. Secondly, the scrubbing medium is also suitable for the absorption of carbon dioxide remaining in the flue gas after the prepurification. The use of the same scrubbing medium for both process steps thereby permits a safe and inexpensive processing of a flue gas.

Advantageously, an amino acid salt is used as scrubbing medium, which amino acid salt is suitable not only for separating off the harmful substances in the flue gas but also for separating off carbon dioxide in the separation apparatus.

In addition, it is advantageous when scrubbing medium flowing off from the scrubbing apparatus, for processing thereof, is fed to a regeneration stage having a number of reclaimers, in which the scrubbing medium is processed for further use.

Advantageously, scrubbing medium flowing off from the or each reclaimer is recycled to the scrubbing apparatus and is thus available for further use. In this case, the scrubbing medium advantageously flows from a first reclaimer to a second reclaimer.

In order to be able to feed the products formed in the or each reclaimer to a further use and/or disposal, the product stream that is formed in the or each reclaimer is expediently fed in each case to a processing appliance.

To carry out the process, it is further advantageous when the scrubbing medium flowing off from the absorber is fed to the desorber, in order there to remove the absorbed CO₂ from the scrubbing medium.

In order to be able to be used for the absorption of carbon dioxide again, scrubbing medium flowing off from the desorber is expediently recycled to the absorber.

In particular, it is advantageous when scrubbing medium flowing off from the desorber is fed at least in part to the scrubbing apparatus and is there used for removing harmful substances from the scrubbing medium before entry into the CO₂ separation apparatus.

For further use and storage of the carbon dioxide that is separated off in the desorber, it is expedient when said carbon dioxide is fed to a processing appliance.

Particularly, heat from the scrubbing medium flowing off from the absorber is transferred to the scrubbing medium conducted in the scrubbing apparatus, in order in this manner to recover water from the scrubbing apparatus with low expenditure.

In a further advantageous embodiment, heat from the scrubbing medium flowing off from the absorber is transferred to scrubbing medium circulating in the regeneration stage, whereby the heat from the CO₂ separation process can be used for the evaporation and recovery of water in the regeneration stage.

In addition, it is advantageous when the harmful substances and the carbon dioxide are separated off from the gas stream in a shared column in a space-saving manner.

Further advantageous embodiments for the process for processing a gas stream result from the subclaims directed towards the apparatus. The advantages cited for this purpose can be applied to the process correspondingly.

### BRIEF DESCRIPTION OF THE DRAWINGS

Hereinafter, exemplary examples of the invention will be described with reference to a drawing. In the drawings:

FIG. 1 shows an apparatus for processing a flue gas having a carbon dioxide separation apparatus, having a scrubbing apparatus that is flow-connected thereto, and also having a regeneration stage for the scrubbing medium,

FIG. 2 shows a further apparatus for processing a flue gas having a carbon dioxide separation apparatus, having a scrubbing apparatus flow-connected thereto, and also having a regeneration stage for the scrubbing medium, and also

FIG. 3 shows a column as part of a further apparatus for processing a flue gas having an absorber of a carbon dioxide separation apparatus, and a prescrubber of a scrubbing apparatus.

### DETAILED DESCRIPTION OF INVENTION

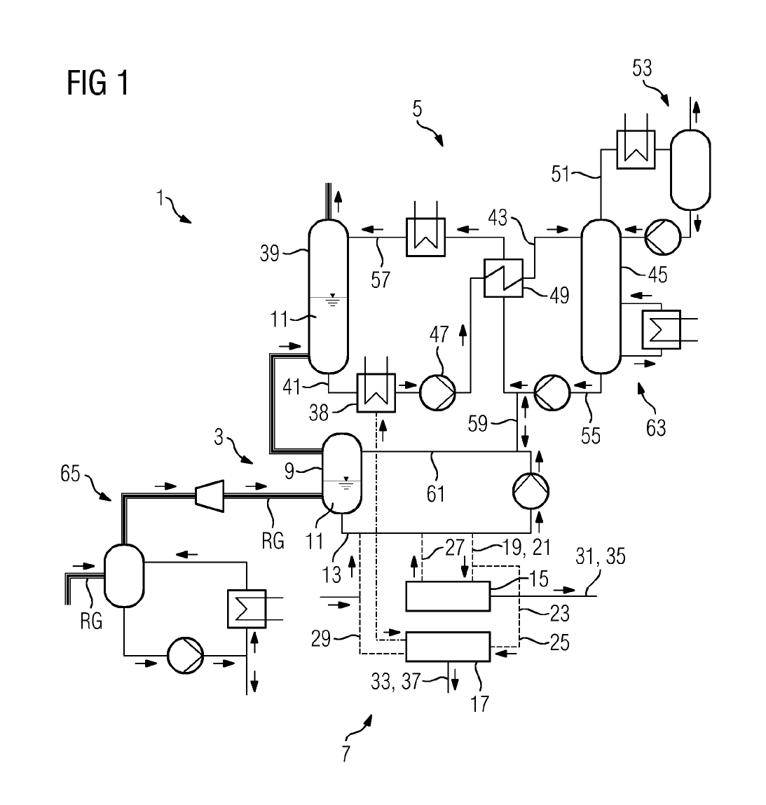

FIG. 1 shows an apparatus 1 for processing a flue gas stream (RG). The apparatus 1 comprises for this purpose a scrubbing apparatus 3 which is flow-connected to a carbon dioxide separation apparatus 5. In addition, the apparatus 1 comprises a regeneration stage 7.

The scrubbing apparatus 3 serves for prepurification of an introduced flue gas stream downstream of the combustion of a fossil fuel. In the prepurification of a flue gas, harmful substances such as, in particular, nitrogen oxides, which form nitrosamines by breakdown products or via side reactions, are removed from the flue gas and thus prevents them from being introduced via the flue gas into the CO₂ separation process in the separation apparatus 5.

For the prepurification, a prescrubber 9 is comprised as part of the scrubbing apparatus 3, in which the flue gas is denitrated. The scrubbing medium 11 used for this purpose is an amino acid salt solution. The flue gas is fed to the regeneration stage 7 after the prepurification in the prescrubber 9 via the recycle line 13 thereof.

The regeneration stage 7 comprises two reclaimers 15, 17, of which the first reclaimer 15 is flow-connected to the scrubbing apparatus 3. The flow connection is permitted via a branch line 19 which is connected to the recycle line 13 of the scrubbing apparatus 3, or of the prescrubber 9. The branch line 19 is flow-connected to the feed line 21 of the first reclaimer 15 of the regeneration stage 7, or opens out therein.

A branch line 23 is likewise connected to the feed line 21 of the first reclaimer 15, which branch line opens out in the feed line 25 of the second reclaimer 17. The scrubbing medium 11 which is withdrawn from the scrubbing apparatus 3 is thus distributed to both reclaimers 15, 17 and processed there correspondingly. Both reclaimers 15, 17 each comprise a recycle line 27, 29, via which they are flow-connected to the recycle line 13 of the scrubbing apparatus 3. Thus the scrubbing medium 11 that is processed in the reclaiming process after interfering components and water are separated off is again fed to the scrubbing apparatus 3 and thereby to the prescrubber 9 and there used for further separation of harmful substances from the flue gas.

The products that are separated off during the purification in the reclaimers 15, 17 are fed via a corresponding outlet line 31, 33 to a processing appliance 35, 37, respectively. The products formed in the reclaiming processes of the scrubbing medium 11 such as, in particular, potassium sulfate, water and waste products, can be correspondingly further processed in the processing appliances 35, 37 that are connected to the reclaimers 15, 17. The processing appliances 35, 37 are in the present case only indicated by corresponding arrows.

In addition, the second reclaimer 17 is thermally connected via a heat exchanger 38 to the CO₂ separation apparatus 5. The heat from the CO₂ separation process can be used in this way, for example, directly for evaporation of water in the regeneration stage 7.

After the prepurification in the first process stage, that is to say the scrubbing apparatus 3, the flue gas correspondingly freed from harmful substances is passed on into the CO₂ separation apparatus 5. For this purpose, the flue gas is fed to an absorber 39. In the absorber 39 there is likewise an amino acid salt solution as scrubbing medium 11 that is utilized to separate off the carbon dioxide present in the flue gas. For this purpose, the flue gas in the absorber 39 is brought into contact with the scrubbing medium 11 and the CO₂ present in the flue gas is absorbed in the scrubbing medium 11. Via an outlet line 41, the absorber 39 is flow-connected to the feed line 43 of a desorber 45, in such a manner that the CO₂-loaded scrubbing medium 11 is pumped by means of a pump 47 into the desorber 45 via these two lines 41, 43, with temperature increase.

In this case the loaded scrubbing medium 11 passes through a heat exchanger 49, in which the heat of the regenerated scrubbing medium 11 flowing from the desorber 45 to the absorber 39 is transferred to the loaded scrubbing medium 11 that is supplied from the absorber 39. The heat exchanger 49 in this case uses the waste heat of the desorber 45 to preheat the scrubbing medium 11 from the absorber 39 before entry into the desorber 45.

Within the desorber 45, the CO₂ that is absorbed in the scrubbing medium 11 is thermally desorbed. For processing and transfer of the carbon dioxide, an outlet line 51 is connected to the first desorber 45, which outlet line opens out in a processing appliance 53. In the processing appliance 53, the desorbed CO₂-rich gas stream can be compressed, in order, for example, to permit transport to a storage site.

In addition, a recycle line 55 is connected to the first desorber 45. The recycle line 55 is flow-connected to the feed line 57 of the absorber 39. The scrubbing medium 11 that is regenerated in the desorber 45 is in this manner recycled to the absorber 39 via the flow connection between the recycle line 55 and the feed line 57 and is available there for renewed absorption of CO₂ from the flue gas.

A branch line 59 is connected to the recycle line 55 of the desorber 45, which branch line is flow-connected to the scrubbing apparatus 3 or to the feed line 61 of the prescrubber 9. Scrubbing medium 11 flowing off from the desorber 45 can in this manner be recycled to the scrubbing apparatus 3 and be regenerated in the two reclaimers 15, 17, via the flow connection of the scrubbing apparatus 3 to the regeneration stage 7. Such an embodiment is a coupled mode of operation between the first process stage in the scrubbing apparatus 3 and the second process stage in the CO₂ separation process. This two-stage mode of operation, that is to say the flow connecting of the scrubbing apparatus 3 to the separation apparatus 5 is made possible, in particular, by the use of the same scrubbing medium 11.

In this case, it is within the scope of a coupled mode of operation also possible in principle to flow connect the outlet line 41 of the absorber 39 to the feed line 61 of the scrubbing apparatus 3, for which purpose, in particular, a branch line can be connected to the outlet line 41 of the absorber 39.

To provide the necessary heat of regeneration for separating the carbon dioxide from the scrubbing medium 11, a reboiler 63 is connected to the desorber 45. The loaded scrubbing medium 11 is regenerated in this case by steam which is generated in the reboiler 63. The reboiler 63 is heated with imported steam, for example from a connected steam power plant, which is not shown in the present case.

In addition, the apparatus 1 comprises a purification stage 65 which is connected upstream of the scrubbing apparatus 3, in which the hot flue gas, after the combustion and before entry into the scrubbing apparatus 3, is precooled by injection of a scrubbing medium. In this case, the harmful substances such as hydrogen chloride (HCl) and hydrogen fluoride (HF) are absorbed, and heavy metals are separated out by what is termed quenching.

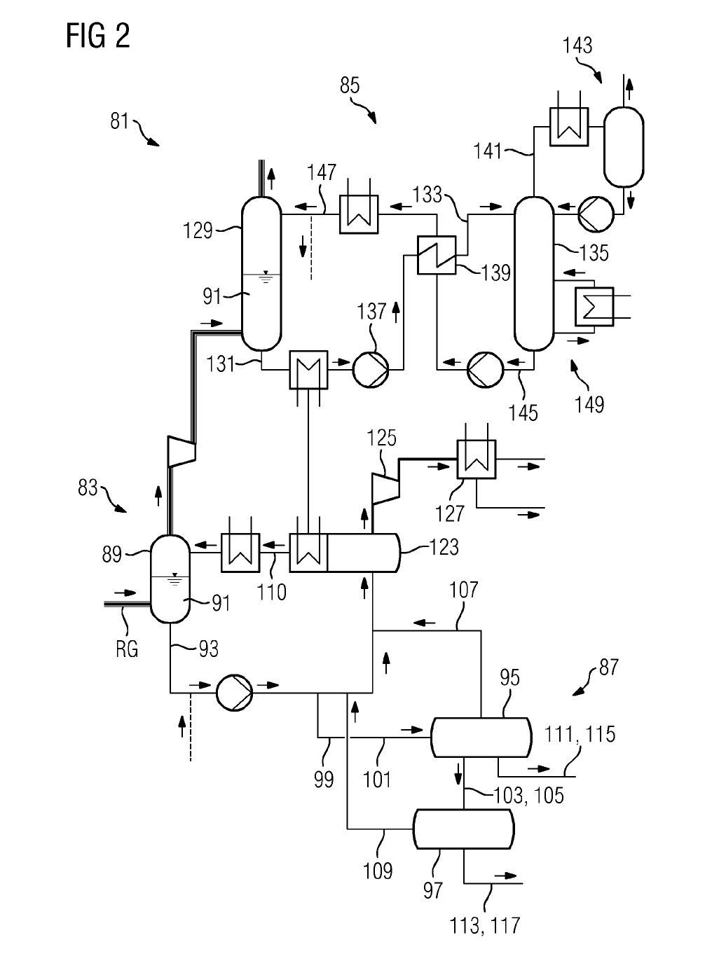

FIG. 2 shows a further apparatus 81 for processing a flue gas stream. As does also apparatus 1 according to FIG. 1, the apparatus 81 comprises for this purpose a scrubbing apparatus 83 which is flow-connected to a carbon dioxide separation apparatus 85, and also a regeneration stage 87.

The scrubbing apparatus 83 serves for prepurification of an introduced flue gas stream after the combustion of a fossil fuel, wherein harmful substances such as, in particular, nitrogen oxides, which form nitrosamines by breakdown products or by side reactions, are removed from the flue gas. For the prepurification, the scrubbing apparatus 83 comprises a prescrubber 89 having an amino acid salt solution as scrubbing medium 91. After the prepurification, the flue gas is fed via a recycle line 93 of the prescrubber 89 to the regeneration stage 87.

The regeneration stage 87 comprises two reclaimers 95, 97. The first reclaimer 95 is connected to the scrubbing apparatus 83 via a branch line 99 that is connected to the recycle line 93 of the scrubbing apparatus 83. In this case, branch line 99 is flow-connected to the feed line 101 of the first reclaimer 95.

A connection line 103 is connected to the first reclaimer 95, which connection line opens out in the feed line 105 of the second reclaimer 97. The scrubbing medium 91 that is processed in the first reclaimer 95 can in this manner be further regenerated in the second reclaimer 97. The processed scrubbing medium 91 is then fed 1, proceeding from both reclaimers 95, 97, to the scrubbing apparatus 83 via two return lines 107, 109 that are connected to the reclaimers 95, 97 and there recycled to the prescrubber 89 for renewed purification of the flue gas via a feed line 110.

The products that are separated off in the reclaimers 95, 97 during the purification of the scrubbing medium 91 are fed via a corresponding outlet line 111, 113 to a processing appliance 115, 117, respectively. Here also, the processing appliances 115, 117 are only indicated by arrows.

In contrast to the apparatus 1 according to FIG. 1, in the present case, it is not the regeneration stage 87, but rather the scrubbing apparatus 83 that is thermally connected to the CO₂ separation apparatus 85. This is achieved via a thermal coupling of a heat exchanger 119 of the separation apparatus 85 to a heat exchanger 121 of the scrubbing apparatus 83. In this manner, without additional heat input, waste heat from the main process can be used, for example for evaporating water in the scrubbing apparatus 83. For recovery of water used, for which purpose an evaporator 123, a compressor 125 and a steam condenser 127 for liquefying the steam are connected to the heat exchanger.

After the prepurification in the scrubbing apparatus 83 or in the prescrubber 89, the flue gas is passed on into an absorber 129 of the CO₂ separation apparatus 85. In the absorber 129, likewise, an amino acid salt solution is used as scrubbing medium 91 for the carbon dioxide present in the flue gas. After the absorption of the carbon dioxide, the scrubbing medium 91 is pumped with temperature increase by means of a pump 137 into a desorber 135 via an outlet line 131 of the absorber 129 and a feed line 113 of the desorber 135 which is flow-connected thereto.

Via a heat exchanger 139, the heat of the regenerated scrubbing medium 91 that is flowing from the desorber 135 to the absorber 129 is transferred to the loaded scrubbing medium 91 fed from the absorber 129. Within the desorber 135, the CO₂ that is absorbed in the scrubbing medium 91 is thermally desorbed and fed to a processing appliance 143 for processing and transfer via an outlet line 141 connected to the desorber 135.

Via a recycle line 145 that is connected to the desorber 135 and is flow-connected to the feed line 147 of the absorber 129, the scrubbing medium 91 that is regenerated in the desorber 135 is recycled to the absorber 129 and is there available for renewed absorption of CO₂ from the flue gas.

A further difference from FIG. 1 is in the present case that no branch line is connected to the recycle line 145 of the desorber 135 for flow connecting to the scrubbing apparatus 83. This is therefore in this case a separate operating mode of the first process stage (prepurification) and of the second process stage (CO₂ separation).

To provide the necessary heat of regeneration for the separation of the carbon dioxide from the scrubbing medium 91, likewise a reboiler 149 is connected to the desorber 135. The loaded scrubbing medium 91 in this case is regenerated by steam from the reboiler 149.

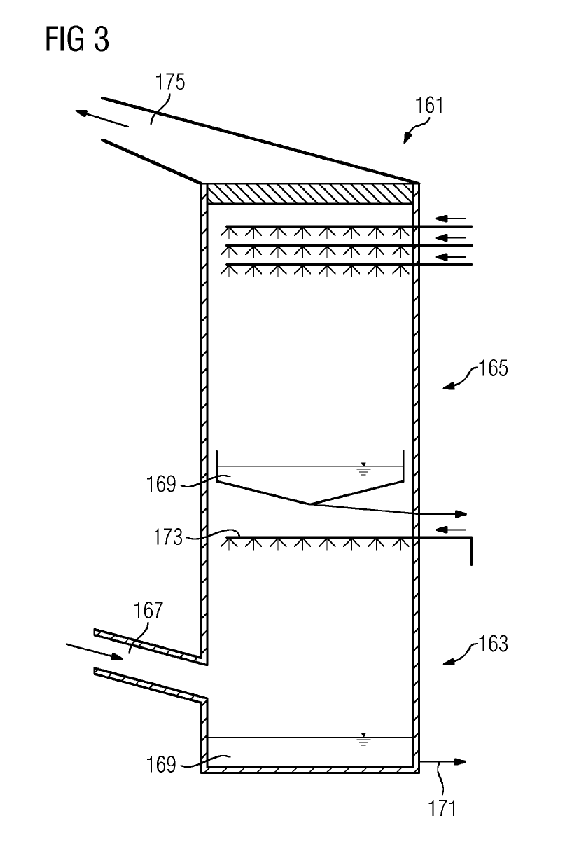

FIG. 3 shows a column 161 as part of a further apparatus for processing a flue gas stream. In the column 161, a scrubbing apparatus 163 and an absorber 165 are arranged together as part of a carbon dioxide separation apparatus. In this manner, the cooling of the flue gas stream, the separation off of the harmful substances and the carbon dioxide separation can be arranged in a space-saving manner.

The flue gas is blown in for this purpose via an inlet 167 into the lower part of the column 161 and there freed from harmful substances by means of an amino acid salt solution 169. The scrubbing medium 169 is then fed to a regeneration stage 171 having a number of reclaimers, which in the present case is indicated by an arrow leading away from the scrubbing apparatus 163. After the purification or regeneration of the scrubbing medium 169, it is recycled to the lower part of the column 161 and distributed again via a spraying appliance 173.

The purified flue gas, after the prepurification, ascends into the upper part of the column 161 which serves as absorber 165 of the carbon dioxide separation. Here also, the scrubbing medium 169 used is the same amino acid salt solution as in the scrubbing apparatus 163 in the lower part of the column 161. In the absorber 165, the carbon dioxide present in the flue gas is removed and the loaded scrubbing medium 169 is fed to a desorber which is not shown. After the purification, the scrubbing medium 169 is recycled back to the absorber 165 of the column 161. The completely purified flue gas finally leaves the column 161 via an outlet 175.

With respect to the further description of the individual processes during the flue gas purification, at this point, reference is made to the detailed description with respect to FIGS. 1 and 2. In this case, of course, there is fundamentally the possibility of accommodating in a shared column the prepurification in the scrubbing apparatus 3, 83 and the following carbon dioxide separation apparatus 5, 85, not only in the apparatus 1 according to FIG. 1, but also in the apparatus 81 according to FIG. 2.

1.-30. (canceled)

31. An apparatus for processing a gas stream, comprising
a scrubbing apparatus for removing harmful substances from the gas stream by a scrubbing medium,
a separation apparatus connected downstream of the scrubbing apparatus and having an absorber and a desorber for separating off carbon dioxide from the gas stream by a scrubbing medium, and also
a regeneration stage for the scrubbing medium having a number of reclaimers,
wherein the scrubbing apparatus and the separation apparatus are adapted to use the same scrubbing medium, and
wherein the regeneration stage is flow-connected to a recycle line of the scrubbing apparatus.

32. The apparatus as claimed in claim 31,
wherein an amino acid salt is used as scrubbing medium.

33. The apparatus as claimed in claim 31,
wherein the recycle line of the scrubbing apparatus comprises a branch line which is flow-connected in each case to a feed line of the or each reclaimer.

34. The apparatus (1, 81) as claimed in claim 31,
wherein the or each reclaimer comprises a recycle line which is flow-connected in each case to the recycle line of the scrubbing apparatus.

35. The apparatus as claimed in claim 31,
wherein a first reclaimer and a second reclaimer are flow-connected to one another via a connection line.

36. The apparatus as claimed in claim 31,
wherein the or each reclaimer comprises an outlet line which in each case is connected to a processing apparatus.

37. The apparatus as claimed in claim 31,
wherein the absorber of the separation apparatus is flow-connected via an outlet line to a feed line of the desorber.

38. The apparatus as claimed in claim 31,
wherein the desorber of the separation apparatus is flow-connected via a recycle line to a feed line of the absorber.

39. The apparatus as claimed in claim 38,
wherein a branch line is connected to the recycle line of the desorber, which branch line is flow-connected to the feed line of the scrubbing apparatus.

40. The apparatus as claimed in claim 38,
wherein a branch line is connected to the outlet line of the absorber, which branch line is flow-connected to the feed line of the scrubbing apparatus.

41. The apparatus as claimed in claim 31,
wherein an outlet line is connected to the desorber, which outlet line opens out in a processing appliance.

42. The apparatus as claimed in claim 37,
wherein the scrubbing apparatus is thermally connected to the outlet line of the absorber.

43. The apparatus as claimed in claim 37,
wherein the regeneration stage is thermally connected to the outlet line of the absorber.

44. The apparatus as claimed in claim 31,
wherein the scrubbing apparatus and the absorber of the separation apparatus are arranged in a shared column.

45. The apparatus as claimed in claim 31,
wherein a reboiler is connected to the desorber.

46. A process for processing a gas stream, comprising
in a scrubbing apparatus, separating off harmful substances from the gas stream by a scrubbing medium,
feeding the gas stream freed from harmful substances to a separation apparatus to separate off carbon dioxide,
within an absorber of the separation apparatus, separating off the carbon dioxide from the gas stream by a scrubbing medium, and
feeding the loaded scrubbing medium to a desorber of the separation apparatus for desorption of the carbon dioxide,
wherein the same scrubbing medium is used to separate off the harmful substances and to separate off the carbon dioxide from the gas stream, and
wherein scrubbing medium flowing off from the scrubbing apparatus, for processing thereof, is fed to a regeneration stage having a number of reclaimers.

47. The process as claimed in claim 46,
wherein the scrubbing medium used is an amino acid salt.

48. The process as claimed in claim 46,
wherein scrubbing medium flowing off from the or each reclaimer is recycled to the scrubbing apparatus.

49. The process as claimed in claim 46,
wherein scrubbing medium flows from a first reclaimer to a second reclaimer.

50. The process as claimed in claim 46,
wherein a product stream that is formed in the or each reclaimer is fed in each case to a processing appliance.

51. The process as claimed in claim 46,
wherein the scrubbing medium flowing off from the absorber is fed to the desorber.

52. The process as claimed in claim 46,
wherein scrubbing medium flowing off from the desorber is recycled to the absorber.

53. The process as claimed in claim 46,
wherein scrubbing medium flowing off from the desorber is fed at least in part to the scrubbing apparatus.

54. The process as claimed in claim 46,
wherein carbon dioxide that is separated off in the desorber is fed to a processing appliance.

55. The process as claimed in claim 46,
wherein heat from the scrubbing medium flowing off from the absorber is transferred to the scrubbing medium conducted in the scrubbing apparatus.

56. The process as claimed in claim 46,
wherein heat from the scrubbing medium flowing off from the absorber is transferred to scrubbing medium circulating in the regeneration stage.

57. The process as claimed in claim 46,
wherein the harmful substances and the carbon dioxide are separated off from the gas stream in a shared column.
